(19) United States
(12) Patent Application Publication
(10) Pub. No.: US 2004/0140957 A1
(43) Pub. Date: Jul. 22, 2004

(54) Practice keyboard with automatic speed control of recorded dictation tapes

(76) Inventor: James E. Casey, Sun City West, AZ (US)

Correspondence Address: James E. Casey, 12910 Butterfield Drive, Sun City West, AZ, 85375, US

(21) Appl. No.: 10/459,753

(22) Filed: Nov. 12, 2003

Related U.S. Application Data
(60) Provisional application No. 60/389,599, filed on Jun. 18, 2002.

(51) Int. Cl. G09G 5/00

(52) U.S. Cl. 345/168

(57) ABSTRACT

An alpha-numeric computer keyboard is designed with a built-in stereo and electronic switching circuitry to enable students (users) to build proper key boarding skills and develop speed in the shortest possible time. Students listen to the recorded instructions on the tape and transcribe groups of letters, words, phrases, sentences, numbers, and symbols/punctuation marks as they are dictated, using the proper finger to strike each key. The dictation is stopped by a signal on the tape and restarted when the student depresses the last key of the segment, making the speed completely natural for each student to build speed while developing skill. This is accomplished by wiring specific keys, for example Space, Period and Enter as momentary switches which are connected to a selection switch for restarting the tape each time the last key of a segment is depressed by the student so that the next item can be heard immediately.

### CROSS REFERENCE TO RELATED APPLICATIONS

PROVISIONAL PATENT APPLICATION #60/389,559 FILED Jun. 18, 2002

### BACKGROUND OF THE INVENTION

This invention is designed to teach users computer keyboard mastery in three hours. The unit is controlled by both the user (student) and a specially prepared tape driven by a built-in stereo tape player.

The abundance of computer keyboards in the business world today has created a demand for employees with proper keyboarding skills which far exceeds the availability. Both schools and businesses are seeking ways to quickly train people to use keyboards properly so that with daily use they will continue to gain speed and accuracy.

While recorded keyboarding courses, which can be used at a variety of speeds, have proven to be successful in the building of typing (keyboarding) skills, they can be very frustrating when they are either too fast or too slow for the learner for example a sudden need to correct an error will cause students (users) to miss portions of recorded material.

This invention does not lock the keyboard nor does it provide a record, either by monitor or print, of the material keyed by the student. It is only natural to backspace and correct any mis-key that is recognized immediately. All other errors remain unknown so that the time can be better spent practicing.

Controls that can stop, restart and rewind the tapes are available aand do overcome some of the problems. However, alternative manual controls are a serious distraction for students concentrating on the learning of proper keyboarding techniques. Also, foot and hand controls are often a nuisance and tend to impede learning the proper hands-on applications.

### SUMMARY

This invention plays dictated matter from a series of specially prepared tapes at speeds perfectly matched to the ability of the student (user) so that proper computer keyboarding skills can be developed as rapidly as possible.

### OBJECTS AND ADVANTAGES

Some of the objects and advantages of this invention are:

(a) to satisfy the need to learn how to master computer keyboard entry properly in a minimum amount of time so that each subsequent use of a keyboard will result in increased speed and accuracy.

(b) to permit the exact timing of recorded exercises, which are controlled by the student, to enable her/him to learn proper computer keyboarding skills in as little time as possible.

(c) to permit students (users) to progress in speed as they progress in their ability to strike each key with the proper finger. Tapes are dictated as alphabetic items, puncuation marks, symbols, words, phrases and sentences, with a pause signal after each. Any keys which have been preset on the selection switch will restart the tape each time they are depressed as an item.

(d) to satisfy the need to learn proper keying skills at maximum speeds with improved accuracy in a minimum amount of time, permitting all users to keyboard with the proper touch in much less time than required with traditional keyboarding programs.

(e) During development tests for this invention, most students with speeds matched to their ability, reached basic skill levels on the keyboard in less than three hours of ten minute sessions. This is only only a fraction of the time usually devoted to these types of courses whether or not they are supported by audio tapes.

(f) An audio tape player built into an alpha-numeric keyboard with specially designed circuitry is connected in a way that depressing specific keys causes the tape to start playing the dictation recorded on one track of the stereo system and stop playing the dictation when it senses a stop signal recorded on the other track.

(g) A number of different devices are available for a variety of dictated materials. None however, are able to control speed solely by the student's (user's) use of the keyboard.

(h) The recommended components for this invention include the alternate keyboard with built-in audio tape player, electronic switching circuitry, audio earpiece, and a booklet containing the material being dictated. When students use this invention to master computer keyboarding skills they are simultaneously using the three modalities of sight, hearing, and doing which contribute to reinforcing the learning process.

### OBSERVATIONS

The speed of the dictation completely controlled by the user (student) is perfectly comfortable at all times. Also, the user never needs to touch anything but the proper keys for the speed to be controlled automatically. Totally natural operation of the keyboard causes the advance of recorded material as needed.

Lessons are recorded and speed is variably controlled by user. The electonic teaching unit with audio dictation and automatic pacing teaches a student how to properly use a keyboard. Initial tests of this unit indicate that most students reach basic skill levels on an alphanumeric computer keyboard in less than three hours of course study using this invention.

### BRIEF DESCRIPTION OF THE VIEWS OF THE DRAWINGS

FIG. 1 shows the top view of the invention—a practice alpha numeric keyboard with a built-in stereo cassette player and control panel.

FIG. 2 shows the upper film layer #11 under the keyboard containing the re-start contact tips #12 and #13.

FIG. 3 shows the middle film layer #1 containing the holes through which the restart contact tips pass.

FIG. 4 shows the lower film layer #3 wired for contacts between #5 and #7 or #4 and #6 whenever a key is depressed activating a contact tip.

FIG. 5 is the bottom of the keyboard—stereo player unit.

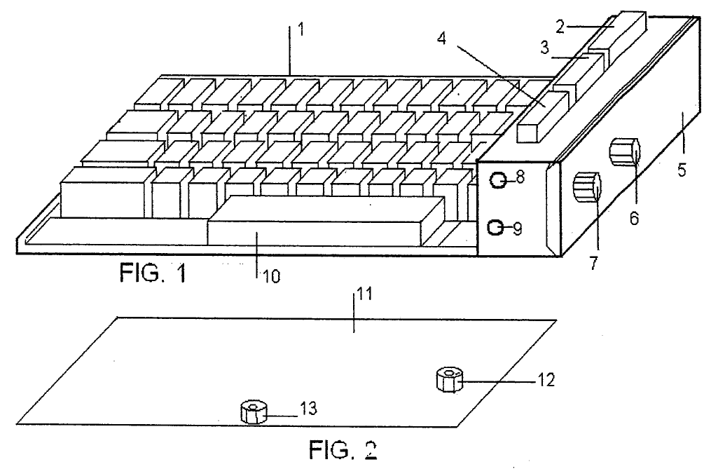

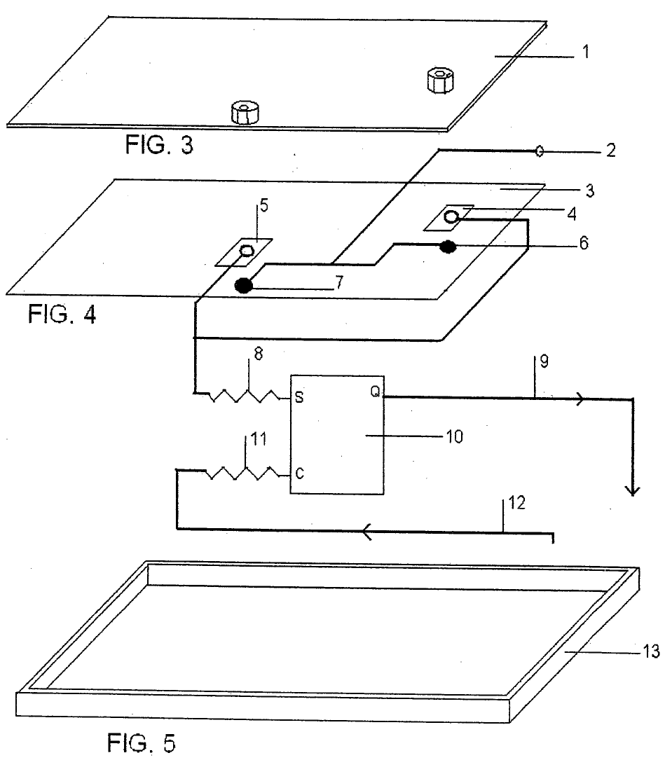

### DETAILED DESCRIPTION OF THE INVENTION

A stereo tape player, built into a modified alpha-numeric keyboard similar to the alpha-numeric portion of a computer keyboard is wired to send signals to a switching circuit whenever a specific key is depressed. This method is used to restart a specially recorded audio tape which has been stopped by a signal on one track containing a voice recording on the other track.

The recording is made up of voice units which may be groups of letters, a word, a phrase, numbers, punctuation marks or a sentence. A stop signal is recorded on the other track of the stereo tape at the end of each unit.

The switching circuit is connected to a stereo tape player and also to a selection switch which controls specific keys on the keyboard. The switching circuit, upon receiving the stop signal from the tape, stops the tape. It restarts the tape when it receives a specific signal from the keyboard. The switching circuit can be set to restart the tape on a signal triggered by depressing one or more keys.

The invention will be used primarily in schools and work environments where computer keyboarding skills are necessary. It offers a quick way to learn to use a computer keyboard properly for speed and accuracy.

Recorded drills and context (lessons) for building student computer keyboarding speed and accuracy skills have been gaining in popularity during the past 25 years. Substantial progress is possible when the material is timed so that it can be played at speeds geared to the student's skill level as she/he learns and progresses. However, frustration is experienced whenever speeds are too fast or too slow for some particular situations. A sudden need to correct an error will often cause students to miss some portions of recorded material.

Controls that can stop and restart the tape are available and do overcome some of the problems. However, alternate hand controls are a serious distraction for students who are concentrating on learning proper computer keyboarding skills. Also, foot and hand controls are often a nuisance and distract the student from the proper hands-on actiion. The speed control depends upon the exact speed of the student's needs. The tape is produced in stereo form using one track for the voice and the other for a stop signal. This is a typical format for timed tapes used in schools or offices with the equipment now available. Tapes on existing equipment will advance only when the pre-set time elapses or a foot or hand control is employed. With these methods, the student hears the dictated material at conversational speeds. The pause time between groups of words is shortened or lengthened so that the student hears the needed number of words a minute. Therefore instead of making tapes for each rate, one tape can be used to achieve all speeds. My invention permits the tape to remain stopped until the student has completed keying each segment of the dictated material, including error correction if necessary. The control device senses the end of the material keyed and immediately advances the tape to dictate the next segment. The completion is sensed from the keyboard when the last key of the dictated material is depressed (space, period, enter, etc.). These keys are wired to a multiple position (selection) switch that can be preset to pass only the appropriate signal to the tape controller.

This invention has as its object the exact timing of recorded exercises to permit students to learn proper keyboarding techniques in the least amount of time so that each student is skilled in properly striking the keys. It uses a modified alpha-numeric computer keyboard with power only to specific keys to control the speed of a specially prepared audio tape so that the student's keying of each item perfectly paces each subsequent item dictated. This system permits students (users) to improve speed as they progress in their ability to properly strike each key.

Tapes are dictated as alphabetic items, words, phrases, sentences, numbers and punctuation and symbol keys followed by a pause signal on an alternate track. When the pause signal is sensed, the tape stops and is restarted when the student presses the last key of that specific dictated item. This feature permits the speed of the tape to pace each student perfectly. Also, it permits students (users) to learn how to use the keyboard properly and at increasing speeds in a minimum amount of time.

Initial tests of this invention indicate that most uaers reach basic skill levels on the alpha-numeric keyboard in less than three hours of course study. This is only a fraction of the time needed in other keyboarding courses whether or not they are supported by audio tapes.

I claim:

1. A combination alpha-numeric keyboard and audio tape player that interacts with the student (user) to teach the proper use of the keyboard in the least amount of time possible, being perfectly timed to the reaction of the student to the voice of the teacher on the tape which stops on each pre-recorded signal and restarts immediately after the student has depressed the last key of the dictated material segment.
